(19) United States
(12) Patent Application Publication
(10) Pub. No.: US 2023/0196313 A1
(43) Pub. Date: Jun. 22, 2023

(54) SYSTEMS AND METHODS FOR ARTIFICIAL INTELLIGENCE/MACHINE LEARNING CENTRIC LOCKBOX DOCUMENT PROCESSING

(71) Applicant: JPMORGAN CHASE BANK , N.A., New York, NY (US)

(72) Inventors: Stephen HOFFMAN, Batavia, IL (US); Samuel BECK, East Brunswick, NJ (US); Alexander ASTLE, Jersey City, NJ (US); Mary Sue MARZULLO, New York, NY (US); Marcelo SOSA, New York, NY (US); Sara J GRANT, New York, NY (US); Vikram PUNSHI, New York, NY (US)

(21) Appl. No.: 17/645,147

(22) Filed: Dec. 20, 2021

(51) Int. Cl. G06Q 20/10; G06F 16/93; G06N 20/00

(52) U.S. Cl. CPC G06Q 20/10; G06F 16/93; G06N 20/00

(57) ABSTRACT

Systems and methods for artificial intelligence/machine learning centric lockbox document processing are disclosed. In one embodiment, a lockbox document processing pipeline may include an imaging engine that receives a plurality of images of lockbox documents; a classification engine that classifies each of the images using a trained machine learning engine; a recognition and extraction engine that recognizes data fields from each of the images and extracts data for each data field; a validation engine that validates data; and a delivery engine that delivers payment for a payment amount identified by extracted data in a first data field of the data fields from a source account identified by extracted data for a second data field of the data fields to a destination account identified by extracted data for a third data field of the data fields.

### BACKGROUND OF THE INVENTION

### 1. Field of the Invention

Embodiments relate generally to systems and methods for artificial intelligence/machine learning centric lockbox document processing.

### 2. Description of the Related Art

Lockboxes are used to receive documents, such as receivables, from clients. Lockbox processing involves scanning the documents to extract key information from checks, invoices, correspondence and other document types, depositing money into the appropriate account, and transmitting key information back to the client. The process is very labor intensive and requires staff to be onsite to intake the mail, scan the documents, and perform various onsite workflow functions.

### SUMMARY OF THE INVENTION

Systems and methods for artificial intelligence/machine learning centric lockbox document processing are disclosed. According to one embodiment, a method for lockbox document processing, comprising: (1) receiving, at an imaging engine in a lockbox document processing pipeline, a plurality of images of lockbox documents; (2) classifying, by a classification engine in the lockbox document processing pipeline, each of the images using a trained machine learning engine; (3) writing, by the classification engine, a classification status for each of the images; (4) recognizing, by a recognition and extraction engine in the lockbox document processing pipeline, data fields from each of the images; (5) writing, by the recognition and extraction engine, a recognition status for each of the images; (6) extracting, by the recognition and extraction engine, data for each data field; (7) writing, by the recognition and extraction engine, an extraction status for each of the images; (8) validating, by a validation engine in the lockbox document processing pipeline, the data; (9) writing, by the validation engine, a validation status for each of the images; and (10 delivering, by a delivery engine in the lockbox document processing pipeline, payment for a payment amount identified by extracted data in a first data field of the data fields from a source account identified by extracted data for a second data field of the data fields to a destination account identified by extracted data for a third data field of the data fields.

In one embodiment, one of the plurality of lockbox documents may include a payment coupon, a check, or an envelope.

In one embodiment, the trained machine learning engine may be trained with historical lockbox documents.

In one embodiment, the data fields may include a courtesy amount field, a legal amount field, a Magnetic Ink Character Recognition (MICR) line field, a memo line field, a date field, a payee name field, a remitter name field, and a signature field.

In one embodiment, the validation may include validating a check negotiability and/or validating a transaction integrity.

In one embodiment, the method may further include notifying a payor and/or a payee of the delivery of payment.

According to another embodiment, a lockbox document processing pipeline may include an imaging engine that receives a plurality of images of lockbox documents; a classification engine that classifies each of the images using a trained machine learning engine and writes a classification status for each of the images; a recognition and extraction engine that recognizes data fields from each of the images, writes a recognition status for each of the images, extracts data for each data field, and writes an extraction status for each of the images; a validation engine that validates data and writes a validation status for each of the images; and a delivery engine that delivers payment for a payment amount identified by extracted data in a first data field of the data fields from a source account identified by extracted data for a second data field of the data fields to a destination account identified by extracted data for a third data field of the data fields.

In one embodiment, one of the plurality of lockbox documents may include a payment coupon, a check, or an envelope.

In one embodiment, the trained machine learning engine may be trained with historical lockbox documents.

In one embodiment, the data fields may include a courtesy amount field, a legal amount field, a Magnetic Ink Character Recognition (MICR) line field, a memo line field, a date field, a payee name field, a remitter name field, and a signature field.

In one embodiment, the validation may include validating a check negotiability and/or validating a transaction integrity.

In one embodiment, the delivery engine may also notify a payor and/or a payee of the delivery of payment.

According to another embodiment, an electronic device may include a memory storing a computer program and a computer processor. When executed by the computer processor, the computer program causes the computer processor to receive a plurality of images of lockbox documents, classify each of the images using a trained machine learning engine, write a classification status for each of the images, recognize data fields from each of the image, write a recognition status for each of the images, extract data for each data field, write an extraction status for each of the images, validate the data, write a validation status for each of the images, and deliver payment for a payment amount identified by extracted data in a first data field of the data fields from a source account identified by extracted data for a second data field of the data fields to a destination account identified by extracted data for a third data field of the data fields.

In one embodiment, one of the plurality of lockbox documents may include a payment coupon, a check, or an envelope.

In one embodiment, the trained machine learning engine may be trained with historical lockbox documents.

In one embodiment, the data fields may include a courtesy amount field, a legal amount field, a Magnetic Ink Character Recognition (MICR) line field, a memo line field, a date field, a payee name field, a remitter name field, and a signature field.

In one embodiment, the validation may include validating a check negotiability and/or validating a transaction integrity.

In one embodiment, the computer program may also cause the computer processor to notify a payor and/or a payee of the delivery of payment.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for artificial intelligence/machine learning centric lockbox document processing according an embodiment; and

FIG. 2 depicts a method artificial intelligence/machine learning centric lockbox document processing according an embodiment.

### DETAILED DESCRIPTION OF PREFERRED EMBODIMENTS

Embodiments are generally directed to systems and methods for artificial intelligence/machine learning centric lockbox document processing.

Embodiments may use embedded machine learning algorithms that are trained on historical lockbox documents to verify, classify, extract, and provide safety nets for the entire process. The outputs of the machine learning algorithms may be integrated with a front end to create a feedback loop between human and machine. Embodiments may scan lockbox documents as early as possible in the workflow and allow machine learning models to perform as many of the pipeline tasks as possible. In general, humans are only involved when there is an exception, or when a task cannot be completed by the algorithm. Human involvement may be virtual through the front end, and the feedback from the human will be used to further train the algorithms.

In embodiments, the algorithms may leverage neural networks that are trained on historic lockbox documents. In embodiments, a feedback loop that targets difficult to process work may also leverage documents specific to lockbox clients to create a more efficient process. Embodiments may also leverage a unique machine learning algorithm to learn per-remitter patterns and leverage those patterns to automate subsequent transactions.

Embodiments may extract data from the invoices (e.g., goods/services, prices, etc.) and may use the data to determine pricing, predict pricing trends, inform a supplier as to how its prices compare to others, etc.

In embodiments, information on receivables in the lockbox may be provided to a cash flow forecasting engine, which may forecast the cash flow for an entity.

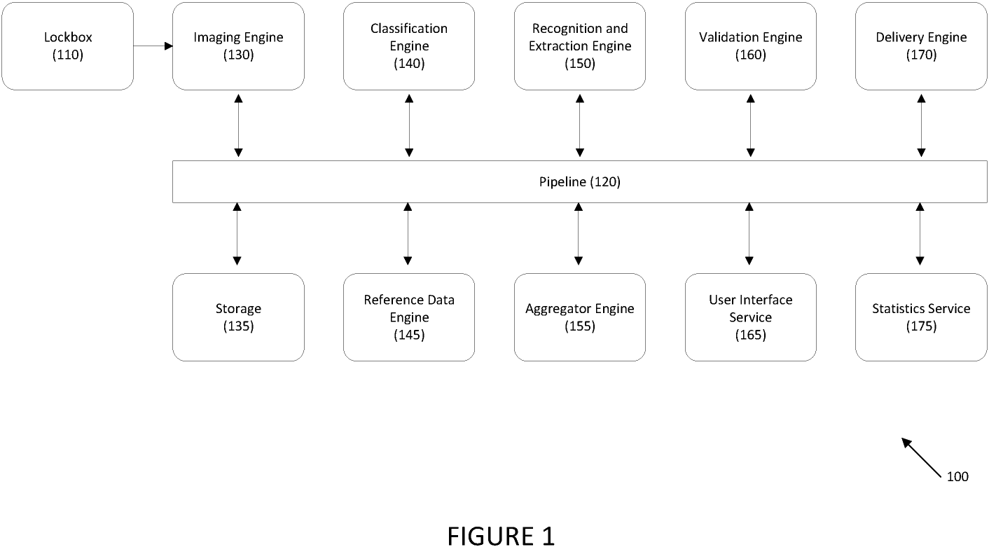

Referring to FIG. 1, a system for artificial intelligence/machine learning centric lockbox document processing is disclosed according to an embodiment. System 100 may include lockbox 110, which may be a physical lockbox or a virtual lockbox, pipeline 120, imaging engine 130, storage 135, classification engine 140, reference data engine 145, recognition and extraction engine 150, aggregator service 155, validation engine 160, user interface service 165, delivery engine 170, and statistics service 175. In embodiments, the engines and services may be microservices that are executed by one or more electronic device, including servers (physical and/or cloud-based), workstations, etc.

In one embodiment, envelopes containing documents, such as payment instruments (e.g., checks) and/or payment coupons may be opened. The documents and the envelopes may be imaged by, for example, a scanner or similar, and may be provided to imaging engine 130, and then to pipeline 120.

In embodiments, imaging engine 130 may further enhance the image for OCR purposes and to improve data extraction. This may include despeckling, rotating, thresholding, denoising, and correcting skew.

Imaging engine 130 may also validate image properties, such as that the image has the requisite resolution. The validation may be based, for example, on business rules. Imaging engine 130 may further perform optical character recognition on the imaged documents.

Once the document is imaged, the imaging status may be written to pipeline 120. Each image may be associate with a file, or may be annotated, to reflect the status of the document. This writing may be used by the subsequent stages in the pipeline to know when to act on document.

Storage 135 may store imaged lockbox documents. In one embodiment, the imaged lockbox documents may be available via an application programming interface (API).

Classification engine 140 may use a trained machine learning engine to classify the imaged lockbox documents. In embodiment, classification engine 140 may classify the imaged lockbox documents as checks, payment coupons, etc. and may return a confidence level. If the confidence level is below a threshold, it may trigger an exception and request human assistance using user interface services 165.

In one embodiment, classification engine 140 may use a trained machine learning engine to classify the imaged lockbox documents.

Embodiments may also predict a rotation of an image of a document during classification based on the type of document and using the trained machine learning engine.

Once the document is classified, the classification may be written to pipeline 120.

In one embodiment, classification engine may further indicate a manner in which the documents or images were received, and this may be provided the lockbox receiver, such as a provider of goods or services. For example, multiple checks may be received for a single invoice, and the lockbox receiver may apply business rules to the documents, payments, deposits, etc., after receiving deposit notification. The grouping or similar indication may be associated with the documents or images as they move through pipeline 120 and may be provided to the lockbox receiver.

Reference data engine 145 may hold client specific references of what data to capture, what rules to apply, how to group and process the work, etc. In embodiment, reference data engine 145 may provide be accessed in real-time for real time data processing.

Recognition and extraction engine 150 may recognize and extract data from the classified documents. For example, recognition and extraction engine 150 may extract check fields, extract payment coupon fields, and may return a confidence level in the extraction. If the confidence level is below a threshold, it may trigger an exception and request human assistance using user interface services 165.

Recognition and extraction engine 150 may also recognize and extract data from the envelope for the document as needed. For example, from a check, recognition and extraction engine 150 may extract the courtesy amount, the legal amount, the Magnetic Ink Character Recognition (MICR) line, the memo line, the date, the payee name, the remitter name, the presence of signature, etc. From envelopes, recognition and extraction engine 150 may extract the post office box, ZIP code, other address information, etc. Form invoices, recognition and extraction engine 150 may extract invoice amounts, invoice numbers, etc.

In one embodiment, recognition and extraction engine 150 may use a trained machine learning engine to identify data fields to extract from the imaged lockbox documents.

Once the document is recognized and the data fields extracted, the recognition status may be written to pipeline 120.

Aggregator service 155 may regroup images of documents that belong to a transaction. For example, a physical piece of mail may have multiple checks, invoices, etc., which may all be processed individually. Aggregator service 155 may regroup the processed images for review by a machine learning engine or a human.

Validation engine 160 may perform certain validations on the imaged document and/or extracted data fields. For example, validation engine 160 may validate check negotiability, validate any client-specific qualifications, validate business rules, validate transaction integrity (e.g., balance checks), validate field specific formatting rules (e.g., validate that a format of an invoice number follows the customer-identified format, etc.), etc.

Once the document and/or envelope is validated, the validation status may be written to pipeline 120.

User interface service 165 may provide an interface for training the machine learning algorithms by providing feedback to the machine learning algorithms. In addition, user interface services 165 may notify a user of any exceptions and may receive resolution thereto. The resolution may be used to train the machine learning algorithms.

Delivery engine 170 may interface with user accounts and may deposit funds to the accounts based on the lockbox documents. In addition, delivery engine 170 may provide notifications to the payors and payees of the completion of payment.

In embodiments, delivery engine 170 may group transactions according to client specifications/preferences, sends checks for clearing and deposit, and integrates the transactions into a payments bus for downstream integration, analytics, billing, and client viewing.

Statistics service 175 may collect statistics for the process. For example, statistics service may capture and aggregate data for audit compliance, operator productivity data, machine learning accuracy, research data, etc. The statistics may be fed back to re-train the machine learning engines, may be output in response to an audit, etc.

Embodiments may further extract data from the invoices (e.g., quantity data, pricing data, etc.) to provide information to lockbox receivers (e.g., suppliers) or payors regarding pricing. This data may further be provided to a third-party aggregator.

The architecture may increase processing speed, throughput, and accuracy by tracking image(s) as they move through the pipeline to deposit.

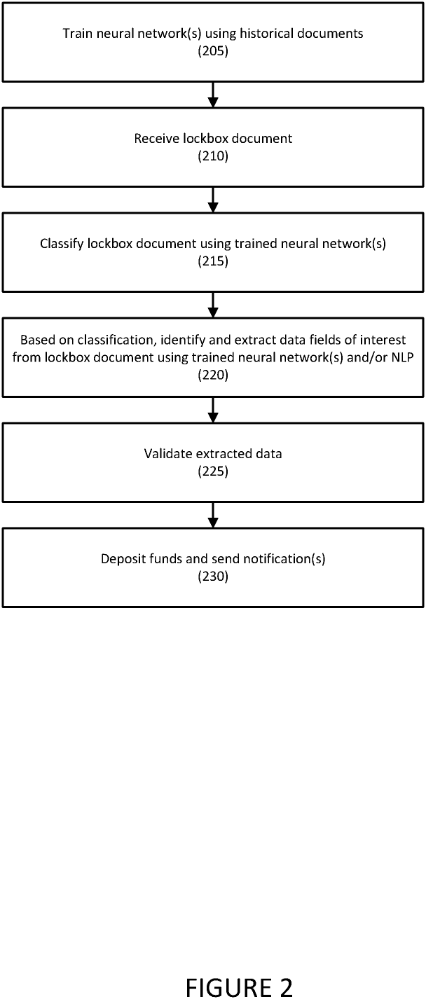

Referring to FIG. 2, a method for artificial intelligence/machine learning centric lockbox document processing is disclosed according to an embodiment.

In step 205, one or more neural networks may be trained using historical lockbox documents. In one embodiment, a first neural network may be trained to classify the lockbox documents, and a second neural network may be trained to recognize and extract data fields from the historical lockbox documents. In one embodiment, a supervised machine learning process may be used. A supervisor may train the neural networks via a user interface service.

In one embodiment, separate trained neural networks may be used; in another embodiment a single trained neural network may be used for classification and for recognition/extraction.

In one embodiment, each lockbox document classification may have its own trained neural network.

In step 210, a lockbox (physical or electronic) may receive a lockbox document. The lockbox document may be received in an envelope, or it may be received electronically.

In one embodiment, the envelope may be opened, and the lockbox document and envelope may be imaged by an imaging engine. The imaging engine may further perform optical character recognition on the image.

In step 215, the imaged lockbox document may be classified using a trained neural network. In one embodiment, a classification engine may classify the imaged lockbox document as a check, a payment coupon, an envelope, etc. and may return a confidence level. If the confidence level is below a threshold, it may trigger an exception and request human assistance using the user interface services.

In one embodiment, a rotation of the document may be predicted based on the classification and/or using a trained machine learning engine. For example, the classification engine may predict that an image should be rotated 0, 90, 180, or 270 degrees based on the classification and a review of the image (e.g., letters are upside down indicates that the image should be rotated).

In one embodiment, images or documents from different envelopes may be grouped together so that the lockbox receiver may apply business rules to the deposits or payments as necessary and/or desired.

In step 220, data fields of interest may be recognized and extracted from the classified document using a trained neural network. In one embodiment, a specific trained neural network may be used for each document classification. For example, a recognition and extraction engine may extract check fields, payment coupon fields, and may return a confidence level in the extraction. If the confidence level is below a threshold, it may trigger an exception and request human assistance using the user interface services.

Data fields from the envelope may also be extracted as necessary and/or desired.

In step 225, the extracted data may be validated. In one embodiment, a validation engine may perform certain validations on the imaged document and/or extracted data fields, such as validating validate check negotiability, business rules, transaction integrity (e.g., balance checks), etc.

In one embodiment, data may be extracted from the documents and may be used to determine pricing for the lockbox receiver, such as the supplier, the purchasers, etc. Embodiments may further determine pricing and/or quantity trends and may make pricing and/or purchasing recommendations based on those trends.

In step 230, the requested funds for the lockbox document may be deposited. For example, a delivery engine may interface with user accounts and may deposit funds to the accounts based on the lockbox documents. The delivery engine may also provide notifications to the payors and payees of the completion of payment.

Embodiments may provide payment and/or deposit information to a cash flow forecasting engine, which may forecast cash flow for the lockbox receiver.

In one embodiment, the notification may be provided individually, in batches, etc.

At any point in the process, checks may be performed to make sure that the lockbox document is being processed by the appropriate lockbox. For example, a check may be made to see if the lockbox document includes an explanation of benefits or similar document that would indicate that the lockbox document is related to medical services. If the lockbox is not a medical services lockbox, an exception may be raised to avoid Health Insurance Portability and Accountability Act of 1996 (HIPAA) issues.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for lockbox document processing, comprising:
receiving, at an imaging engine in a lockbox document processing pipeline, a plurality of images of lockbox documents;
classifying, by a classification engine in the lockbox document processing pipeline, each of the images using a trained machine learning engine;
writing, by the classification engine, a classification status for each of the images;
recognizing, by a recognition and extraction engine in the lockbox document processing pipeline, data fields from each of the images;
writing, by the recognition and extraction engine, a recognition status for each of the images;
extracting, by the recognition and extraction engine, data for each data field;
writing, by the recognition and extraction engine, an extraction status for each of the images;
validating, by a validation engine in the lockbox document processing pipeline, the data;
writing, by the validation engine, a validation status for each of the images; and
delivering, by a delivery engine in the lockbox document processing pipeline, payment for a payment amount identified by extracted data in a first data field of the data fields from a source account identified by extracted data for a second data field of the data fields to a destination account identified by extracted data for a third data field of the data fields.

2. The method of claim 1, wherein one of the plurality of lockbox documents comprises a payment coupon, a check, or an envelope.

3. The method of claim 1, wherein the trained machine learning engine is trained with historical lockbox documents.

4. The method of claim 1, wherein the data fields comprise a courtesy amount field, a legal amount field, a Magnetic Ink Character Recognition (MICR) line field, a memo line field, a date field, a payee name field, a remitter name field, and a signature field.

5. The method of claim 1, wherein the validation comprises validating a check negotiability and/or validating a transaction integrity.

6. The method of claim 1, further comprising:
notifying a payor and/or a payee of the delivery of payment.

7. A lockbox document processing pipeline, comprising:
an imaging engine that receives a plurality of images of lockbox documents;
a classification engine that classifies each of the images using a trained machine learning engine and writes a classification status for each of the images;
a recognition and extraction engine that recognizes data fields from each of the images, writes a recognition status for each of the images, extracts data for each data field, and writes an extraction status for each of the images;
a validation engine that validates data and writes a validation status for each of the images; and
a delivery engine that delivers payment for a payment amount identified by extracted data in a first data field of the data fields from a source account identified by extracted data for a second data field of the data fields to a destination account identified by extracted data for a third data field of the data fields.

8. The lockbox document processing pipeline of claim 7, wherein one of the plurality of lockbox documents comprises a payment coupon, a check, or an envelope.

9. The lockbox document processing pipeline of claim 7, further comprising:
wherein the trained machine learning engine is trained with historical lockbox documents.

10. The lockbox document processing pipeline of claim 7, wherein the data fields comprise a courtesy amount field, a legal amount field, a Magnetic Ink Character Recognition (MICR) line field, a memo line field, a date field, a payee name field, a remitter name field, and a signature field.

11. The lockbox document processing pipeline of claim 7, wherein the validation comprises validating a check negotiability and/or validating a transaction integrity.

12. The lockbox document processing pipeline of claim 7, wherein the delivery engine further notifies a payor and/or a payee of the delivery of payment.

13. An electronic device, comprising:
a memory storing a computer program; and
a computer processor;
wherein, when executed by the computer processor, the computer program causes the computer processor to receive a plurality of images of lockbox documents, classify each of the images using a trained machine learning engine, write a classification status for each of the images, recognize data fields from each of the image, write a recognition status for each of the images, extract data for each data field, write an extraction status for each of the images, validate the data, write a validation status for each of the images, and deliver payment for a payment amount identified by extracted data in a first data field of the data fields from a source account identified by extracted data for a second data field of the data fields to a destination account identified by extracted data for a third data field of the data fields.

14. The electronic device of claim 13, wherein one of the plurality of lockbox documents comprises a payment coupon, a check, or an envelope.

15. The electronic device of claim 13, wherein the trained machine learning engine is trained with historical lockbox documents.

16. The electronic device of claim 13, wherein the data fields comprise a courtesy amount field, a legal amount field, a Magnetic Ink Character Recognition (MICR) line field, a memo line field, a date field, a payee name field, a remitter name field, and a signature field.

17. The electronic device of claim 13, wherein the validation comprises validating a check negotiability and/or validating a transaction integrity.

18. The electronic device of claim 13, wherein the computer program further causes the computer processor to notify a payor and/or a payee of the delivery of payment.
